(19) United States
(12) Patent Application Publication
(10) Pub. No.: US 2026/0202577 A1
(43) Pub. Date: Jul. 16, 2026

(54) METHOD, SYSTEM, AND MACHINE-READABLE MEDIUM FOR MODELING REFLUX DOLOMITIZATION

(71) Applicant: SAUDI ARABIAN OIL COMPANY, Dhahran (SA)

(72) Inventors: Yupeng LI, Beijing (CN); Peng LU, Dhahran (SA)

(73) Assignee: SAUDI ARABIAN OIL COMPANY, Dhahran (SA)

(21) Appl. No.: 19/129,821

(22) PCT Filed: Dec. 19, 2022
(86) PCT No.: PCT/CN2022/139905

§ 371 Date: May 14, 2025

(51) Int. Cl. G01V 20/00; E21B 41/00

(52) U.S. Cl. CPC G01V 20/00; E21B 41/0099; E21B 2200/20

(57) ABSTRACT

A method comprises importing an input depositional geological model of a formation, identifying one or more facies types as a location for one or more evaporation ponds and subsequent dolomite growth, defining dolomitization growth parameters of the one or more evaporation ponds, constructing a dolomite growth model, and integrating the dolomite growth model into an output depositional geological model of the formation including one or more dolomite geo-objects.

### FIELD OF THE DISCLOSURE

The present disclosure relates generally to the modeling of reflux dolomitization, and more particularly to the integration of an object-based modeling approach with a forward depositional model for early dolomitization modeling.

### BACKGROUND OF THE DISCLOSURE

In the characterization of subsurface formations, the presence of a dolomite reservoir may signify a hydrocarbon-rich formation with altered porosity and permeability which will modify the quality of the hydrocarbon reservoir. As such, the accurate modeling of dolomite reservoirs and the prediction of dolomitization locations is an important endeavor for oil and gas explorations and operations.

The dolomite reservoirs may be formed over time through the process of dolomitization, which is a geological process that occurs when calcium ions within calcite, another carbonate material, are replaced by magnesium ions. This process depends on specific conditions that include the Ca/Mg ratio in solution, the reactive surface area, the mineralogy of the reactant, the temperature of the reactive area, and the presence of sulfate. Typical environments of dolomitization include freshwater and seawater mixing zones, normal saline to hyper-saline sub-tidal environments, schizosaline environments (fluctuating salinity: fresh-water to hyper-saline conditions) and hyper-saline supra-tidal environments, and typical facies for dolomitization include packstone, wackestone, and mudstone. When the requirements are fulfilled, dolomitization can even occur in alkaline environments, which are under the influence of bacterial reduction and fermentation processes, and areas with high input alkaline continental ground waters.

For the study and modeling of dolomitization, several models have been developed such as reactive transport models (RTMs). RTMs permit a quantitative investigation of diagenesis and the effects on reservoir quality, including those of dolomitization. RTMs have been used for the simulation of reflux dolomitization and can predict the discrete bodies of non-stratigraphic dolomite as well as the dolomite extents (percentage of limestone being replaced by dolomite). However, RTMs are computationally expensive due to the complex modeling procedure coupling geochemical and geological processes.

As such, the development of a computationally cheaper alternative to RTMs which can integrate accurate dolomitization simulation with depositional modeling is desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method includes importing an input depositional geological model of a formation, identifying one or more facies types as a location for one or more evaporation ponds and subsequent dolomite growth, defining dolomitization growth parameters of the one or more evaporation ponds, constructing a dolomite growth model, and integrating the dolomite growth model into an output depositional geological model of the formation including one or more dolomite geo-objects.

In another embodiment, a system includes an input model communication module operable to import an input depositional geological model, a pond determination module operable to identify one or more facies types of the input depositional geological model as evaporation ponds and dolomite growth locations, a dolomitization growth module operable to receive dolomitization growth parameters as inputs and generate a dolomite geo-object from the dolomitization growth parameters and the dolomite growth locations, and a model integration module operable to integrate the dolomite geo-object into the input depositional geological model to generate an output depositional geological model.

In a further embodiment, a non-transitory machine-readable storage medium stores a computer program for generating a dolomite geo-object and integrating the dolomite geo-object into an input depositional geological model. The computer program includes a routine of set instructions for causing a machine to receive the input depositional geological model from a program on the machine, a database on the machine, a remote machine, or any combination thereof, identify one or more facies types of the input depositional geological model as one or more locations for evaporation ponds and dolomite growth, determine dolomitization growth parameters within the one or more locations for evaporation ponds and dolomite growth, construct the dolomite geo-object from the dolomitization growth parameters and the one or more locations for evaporation ponds and dolomite growth, and integrate the dolomite geo-object into the input depositional geological model, creating an output depositional geological model.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flowchart of an example method for the modeling of dolomite growth according to an embodiment of the present disclosure.

FIGS. 2-10 are example GUIs and outputs of a dolomite growth application involved in the modeling of dolomite growth.

FIG. 11 is an example schematic of a system configured to perform the method of FIG. 1, according to one or more embodiments of the present disclosure.

FIG. 12 is an example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to the modeling of reflux dolomitization, and more particularly to the integration of an object-based modeling approach with a forward depositional model for early dolomitization modeling. The modeling process may include the import, or generation, of results from a forward depositional model, the identification of evaporation ponds within the model results, the definition of dolomitization growth parameters based upon surrounding geometry, and the simulation of dolomite growth using object-based modeling. Further, the modeling process may include outputting the simulation results into a forward depositional model for further use. The modeling process may employ a graphical user interface (GUI), which facilitates the input of the variables as well as the generation and display of the final simulation, as well as an iterative approach to the generation of the final dolomite model.

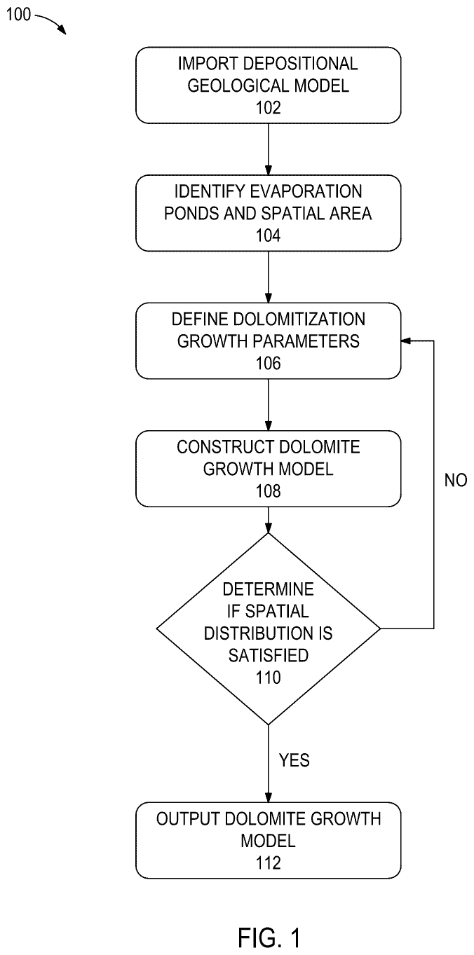

FIG. 1 is a flowchart of an example method 100 for the modeling of dolomite growth according to an embodiment of the present disclosure. While, for purposes of simplicity of explanation, the example method 100 of FIG. 1 is shown and described as executing serially, it is to be understood and appreciated that the present example is not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description. The method 100 may begin at 102 with the import of a depositional geological model for use within the modeling of dolomite growth. The depositional geological model imported at 102 may be generated locally, may be imported from an external source, or may be stored on a database. In some embodiments, the depositional geological model imported at 102 is a forward depositional geological model which includes stratigraphic spatial architectures which may include the thickness of each formation, the lithology within each formation, and the petrophysical properties of the simulated area. The depositional geological model may be imported at 102 manually through data entry or automatically through an input or communication program which facilitates the import of the depositional geological model. Further, the depositional geological model imported at 102 may be a final model output from a separate simulation or may be a step in a series of sub-models which has been imported.

The method 100 may continue at 104 with the identification of the evaporation ponds and the spatial area of the simulation. The identification of the spatial area of the simulation at 104 may be required for the accurate simulation of the dolomitization growth within a confined area of interest, while the identification of the evaporation ponds at 104 may inform the regions of dolomite growth. The method 100 may automatically identify the spatial area of the simulation at 102 as a direct result of the import of the depositional geological model, or the user may be required to manually input the spatial area of the simulation at 104. Similarly, the evaporation ponds may be automatically detected and identified for selection as the location of dolomite growth. In some embodiments, the method 100 provides an interactive way to manually decide which facies are to form the evaporation ponds from the depositional geological model at 104. The interactive determination of the evaporation pond locations may be performed using a top-down view of the depositional geological model which outlines the facies on the surface layer of the simulated region, and may provide one or more default facies types for the growth of dolomite which may be changed manually. The identification of the evaporation ponds and the spatial area of the simulation at 104 may further include an interim visualization denoting the chosen regions for evaporation ponds and individually labelling the chosen regions.

At 106, the dolomitization growth parameters may be defined based upon pond geometry as part of the method 100. The method 100 may provide quantitative parameters for describing the shape of the evaporation pond(s). In some embodiments, the dolomitization growth parameters may be set manually at 106 based upon an understanding of the specific geological depositional process being simulated. In these embodiments, the ability to manually input the dolomitization growth parameters at 106 may enable higher accuracy simulations through the incorporation of simulation-specific knowledge into the method 100, for example from experts in the field (e.g., geologists). The growth speeds of the dolomite may be further obtained from reactive transport models (RTMs) or any additional modeling techniques, without departing from the scope of this disclosure. While RTMs may be prohibitively expensive for the full-scale simulation of dolomite growth over large time-scales, any previously obtained results from RTM simulations may inform the dolomitization growth parameters defined at 106. In some embodiments, further simulations using RTMs may be performed on smaller time-scales in order to further inform the selection of dolomitization growth parameters at 106 for cases in which expert knowledge is lacking.

The method 100 may continue at 108 with the construction of the dolomite growth model based upon one or more of the inputs defined as part of the method 100. The dolomite growth model may be constructed using an object-based stochastic modeling approach which may be faster and computationally cheaper than other modeling approaches, such as through RTMs. The dolomite growth model may be constructed in one or more ways at 108, with an initial model illustrating the simulated dolomite geo-object as part of the simulation and a final depositional model, or output depositional geological model, showing the simulated dolomite geo-object incorporated into a depositional model similar to the depositional geological model imported at 102. It should be noted that the use of “final” in this context refers only to the final step within the dolomite growth modeling process, and that the final depositional model may be further utilized or modified without departing from the scope of this disclosure.

Following the construction of the dolomite growth model at 108, the method 100 may continue at 110 with the determination of whether the desired spatial distribution is satisfied. The method 100 may automatically determine impossible or unphysical spatial distributions at 108, and may additionally enable manual determination of the correctness of the spatial distribution. In any instance which fails to satisfy the desired spatial distribution, the method 100 may continue at 106 with the re-definition or adjustment of the dolomitization growth parameters and the possible iteration of the method through 106, 108, and 110 until the desired spatial distribution is satisfied. In some embodiments, a failure to satisfy the desired spatial distribution at 110 may enable the method to further modify the inputs and may enable further iteration through the method including 102 and 104.

Once the desired spatial distribution is satisfied at 110, the method 100 may continue at 112 with the output or export of the dolomite growth model generated at 108. The dolomite growth model developed through the method 100 may be the desired end goal of the simulation process, or may be utilized in further simulations and geological models. In some embodiments, the dolomite growth model may be exported to the same simulation or program which provided the input to the method 100 at 102. In these embodiments, the method 100 may be incorporated into a larger process, with the method 100 utilized for the generation of a dolomite growth model before the continuation of a separate modeling process (e.g., a forward depositional model). The dolomite growth model output at 112 may be utilized as an initial surface template for a further depositional step in a geological simulation, and may integrate a depositional model with an object-based dolomite geological model while enabling the inclusion of expert knowledge in the method 100.

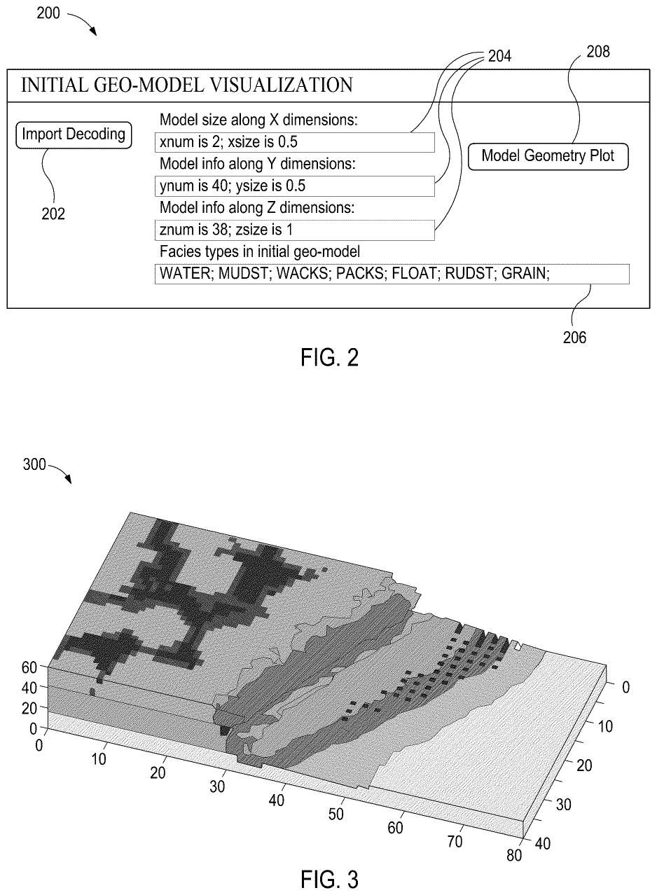

FIGS. 2-10 are example GUIs and outputs of a dolomite growth application involved in the modeling of dolomite growth. FIGS. 2-10 may reflect components and interim results of the method 100 of FIG. 1 and may depict an example dolomite growth simulation according to an embodiment of the present disclosure. Referring first to FIG. 2, an example import window 200 for the initialization of the depositional geological model is shown, as outlined at 102 of method 100. The import window 200 may include an import button 202 which enables the user of the dolomite growth application to import a decoded file containing the depositional geological model to be utilized. The import button 202 may initiate a system prompt which enables the selection of a file stored either locally or in the cloud. In some embodiments, the import button 202 enables the import of any model file previously generated, while in alternate embodiments the import button 202 restricts the choice of file to a file type corresponding to a previously interpreted model.

After the import of the model file, or of the decoding corresponding to the model file, one or more parameters from the model file may be displayed within the import window 200. In dimensional boxes 204, the size of the model in the x-, y-, and z-dimensions may be displayed for the imported model. The dimensional boxes 204 may include the number of divisions, or cells, in the measured direction (shown in FIG. 2 as xnum, ynum, and znum) as well as the length of each division (shown in FIG. 2 as xsize, ysize, and zsize). The import window 200 may additionally display a series of facies types imported from the depositional geological model in facies box 206. Facies box 206 may display the series of imported facies in a separated list as shown in FIG. 2. The order of the facies in the facies box 206 may directly correlate to a numbering system utilized further herein, such that the first listed facies type may be denoted as facies type 0 and the seventh listed facies type may be denoted as facies type 6. It should be noted that the ordered numbering of the facies types may use a different standard or convention without departing from the scope of this disclosure.

Following the verification of the information listed in dimensional boxes 204 and the facies box 206, a geometry plot may be modeled from the import window 200 through the selection of the model geometry button 208. The model geometry button 208 will enable a final validation of the input model through the plotting of the imported model in a three-dimensional format. FIG. 3 displays an example 3D visualization 300 of an initial depositional model, with an isometric view enabling the visual verification of each dimension, as well as a delineation between each facies type based upon color/boundary shape. Following the validation of the imported model via the 3D visualization 300, the dolomite growth application may continue with the determination of pond location as outlined at 104 of method 100.

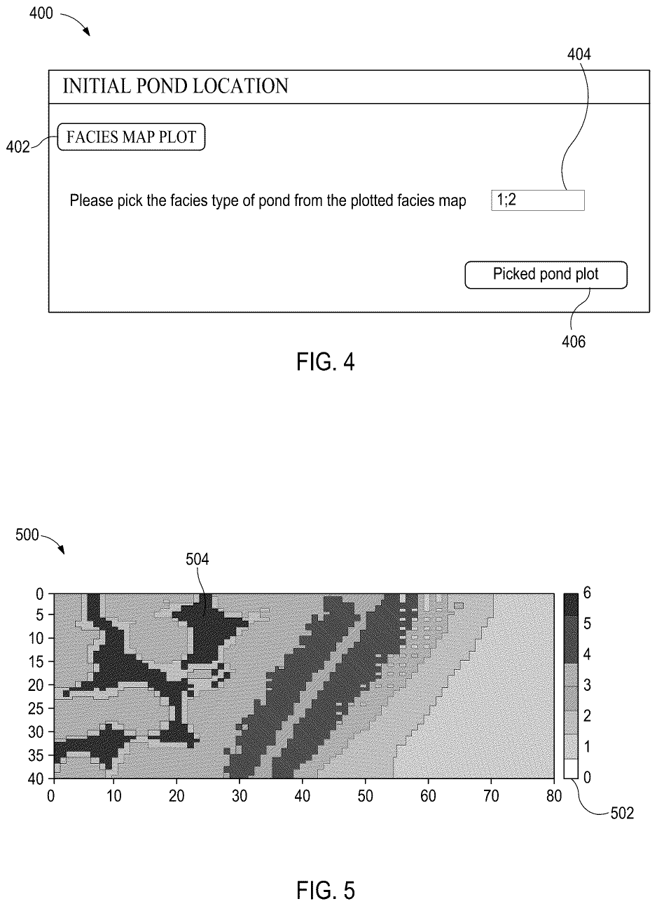

FIG. 4 displays a pond location window 400 which may follow the display of the 3D visualization 300, and may enable the identification of the evaporation ponds wherein the dolomite growth will occur. The pond location window 400 may contain a facies map button 402 which displays a plot of the facies map with the facies numbering previously discussed in FIG. 2. Referring briefly to FIG. 5, an example plot of the facies map 500 is illustrated. The plot of the facies map 500 may be seen as a top-down, two-dimensional view which delineates each facies type and which may represent a depositional step within a forward modeling depositional code. The plot of the facies map 500 may include a legend 502 which displays the facies type as a color and a number, such that the appropriate facies type may be selected in the pond location window 400. The facies types described in the legend 502 may then correspond to the depicted facies 504 within the plot. The plot of the facies map 500 may be shown in full-color, in gray-scale, or with a patterned delineation between each of the depicted facies 504.

Returning now to FIG. 4, the facies map button 402, and the corresponding plot of the facies map 500, may be used to inform the facies selection which is provided in pond selection box 404. Pond selection box 404 may be used for the selection of specific facies which will represent the evaporation ponds in which the dolomite may grow. The pond location window 400, and the underlying dolomite growth application, may provide a default value for the pond selection box 404. In some embodiments, the default value for the pond selection box 404 may be 1 and 2, which correspond herein to mudstone and wackestone as they are muddy facies deposited in a low water energy depositional environment. However, based upon the expertise of the user, or the specific qualities of the simulated depositional geological model, the values in the pond selection box 404 may be changed. After the determination of the facies to be selected within the pond selection box 404, a pond plotting button 406 may be provided by the pond location window 400.

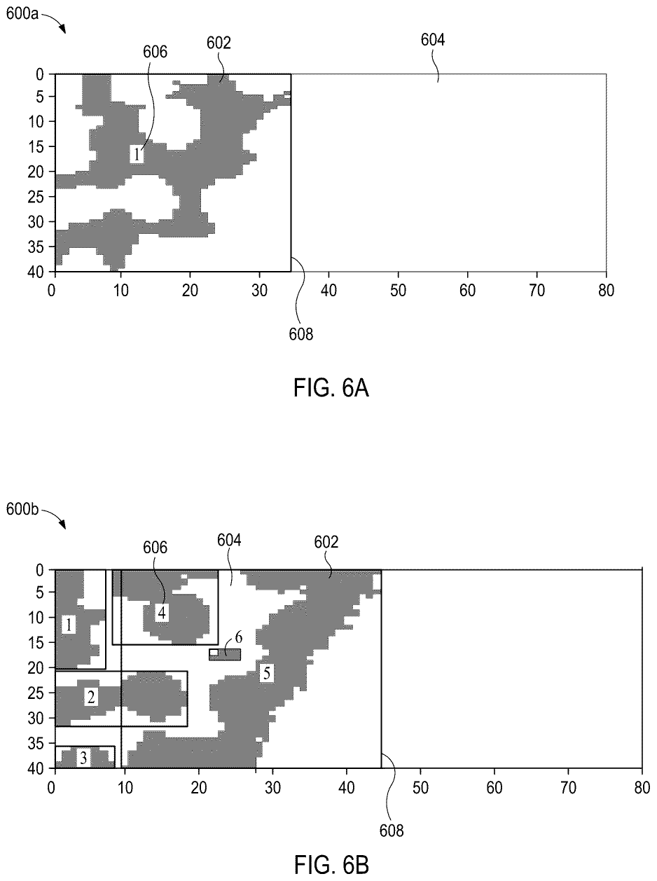

FIG. 6A displays an example pond plot 600a which displays the selected pond areas. The pond plot 600a displays the pond area 602 in a different color, grayscale value, or pattern, from the remaining facies 604 which are treated as a background to the pond plot 600a. The individually defined ponds may be denoted with a pond number 606, and may be bounded by a pond box 608 which is auto-generated based upon the size of the pond area 602. In FIG. 6A, the pond plot 600a shows the pond area 602 for the default pond selection of mudstone and wackestone, while FIG. 6b displays a similar pond plot 600b for the pond selection of packstone. In FIG. 6B, the pond area 602 may be seen as multiple individual ponds which each contain their own pond numbers 606 and are each bounded by their own pond boxes 608. The facies previously defining the pond area 602 in FIG. 6A may now be seen as a part of the remaining facies 604 which make up the background of the plotted area.

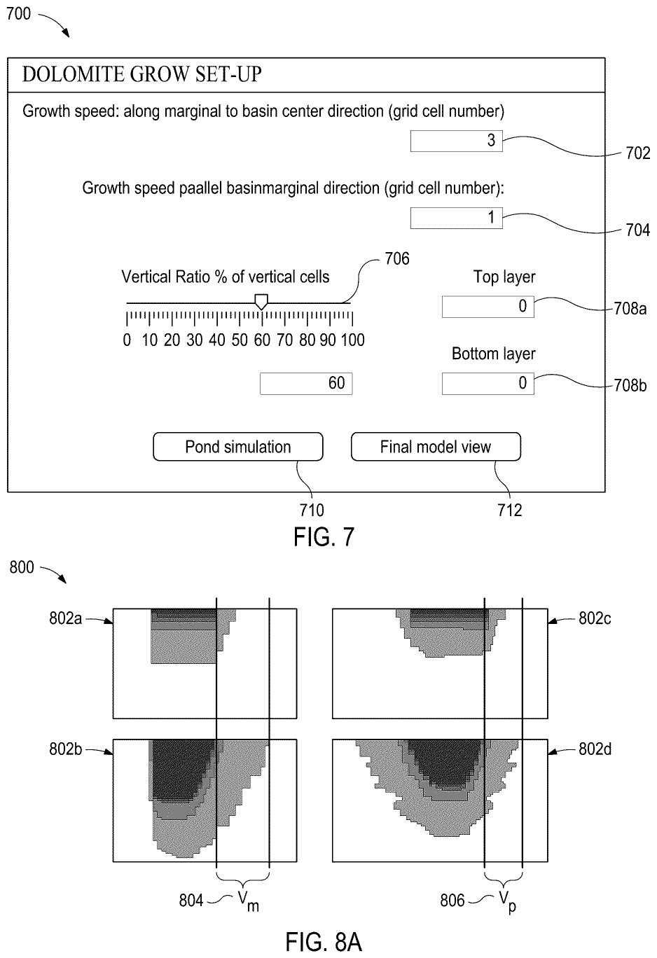

Regardless of the number of ponds or facies selected in the pond location window 400, the definition of the dolomite grow parameters may be performed utilizing the growth parameter window 700 of FIG. 7. The growth parameter window 700 may include several boxes for the definition of the dolomite growth parameters in each dimension, and the operation of the growth parameter window 700 reflects step 106 of the method 100. A first growth parameter box 702 may represent the growth speed of the dolomite along the direction from the margin of the simulation to the basin, or lower area, of the model which may be represented by Vₘ herein. Similarly, the second growth parameter box 704 represents the growth speed of the dolomite along the direction parallel to the coast line of the model which may be represented by Vₚ herein. Referencing FIGS. 6A and 6B as an example, the first growth parameter box 702 represents growth in the horizontal direction while the second growth parameter box 704 represents growth in the vertical direction on the top-down view of the pond plots 600a,b. The growth parameters defined within the first and second growth parameter boxes 702 and 704 may depend upon gravity, density, water head, and elevation differences when determining the reflux flow direction within each growth direction. The values of Vₘ and Vₚ specifically represent the extent of growth within the prescribed timeframe and thus may be further broken down or discretized.

The growth parameter window 700 may further include a slider 706 for the input of a vertical ratio, or Vᵣ, which is the ratio of the number of dolomite cells grown versus the total space available for dolomite growth. The total space available for dolomite growth may be calculated via the inputs in layer boxes 708a,b. The first layer box 708a represents the cellular index of the top layer, while the second layer box 708b represents the cellular index of the bottom layer of the possible pond growth area. In this way, the value of 708b subtracted from the value of 708a may yield a possible number of layers in which the dolomite may grow. The difference between 708a and 708b may then be multiplied by the value of Vᵣ defined by slider 706 to yield the actual vertical growth in the prescribed timeframe.

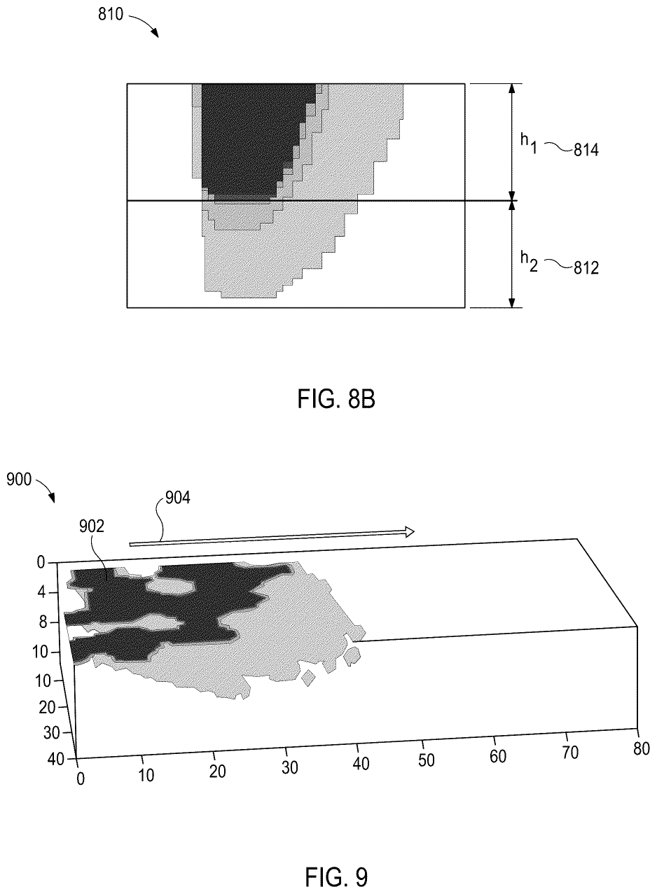

Referring briefly to FIG. 8A, the marginal and parallel growth rates defined in the first and second growth parameter boxes 702 and 704 may be seen in the plot 800. The subplots 802a-d within the plot 800 display different views of the dolomite growth at different angles. The subplots 802a and 802c show the initial pond sizes and shapes prior to the dolomite growth in subplots 802b and 802d, respectively. The subplot 802b shows the growth extent Vₘ 804 within a cross-sectional view along the direction from the shore to the basin. Similarly, subplot 802d displays the growth extent Vₚ 806 that is within a cross-sectional view along the direction parallel to the shore. The dolomite growth extents are shown here across a certain discretized time, such as one million years, and the speed of growth may be further broken down into a smaller discretization such as a number of cells of dolomite growth per one hundred thousand years for example.

Referring briefly now to FIG. 8B, the vertical growth ratio defined by the slider 706 as well as the total area defined by 708a,b may be similarly seen in the plot 810. Within the plot 810, which may be taken from any of the previous cross-sectional views, the vertical growth ratio may be calculated using a first distance 812 from the bottom of the available layers to the bottom of the original pond, or h₀, and a second distance 814 from the top of the available layers to the bottom of the original pond, or h₁. With the values for the first and second distances 812 and 814, the vertical growth ratio Vᵣ may be found using:

$${V}_{r} = \frac{{h}_{0}}{{h}_{0} + {h}_{1}}$$

Returning briefly to FIG. 7, the final dolomite shape may then be determined using a combination of the three parameters Vₘ, Vₚ, and Vᵣ. The three parameters may be determined from the simulation results from a prior or simultaneous modeling effort such as an RTM simulation, or may be decided by an expert based upon an understanding of the geological background and processes. Once the three parameters have been decided, an initial model of the dolomite growth may be seen through the selection of a pond simulation button 710 within the growth parameter window 700.

Referring now to FIG. 9, the output of the pond simulation button 710 may be seen in the example pond model 900. The example pond model 900 displays the growth of the dolomite based upon the parameters defined in the growth parameter window 700 of FIG. 7. The dolomite geo-object 902 is shown in a 3D model which contains a uniform background representing all other facies not selected in the pond location window 400 of FIG. 4. In this way, the dolomite geo-object 902 may be visualized in its entirety without the view of the entire depositional model. From the dolomite geo-object 902, it may be seen that the growth of the dolomite geo-object 902 may depend upon the reflux flow direction 904 as well as the growth parameters. The effects of the reflux flow direction 904 may be seen in the extended growth of the dolomite “sea-ward”, or towards the basin previously defined, while the growth is hampered “shore-ward”, or towards the marginal shore-line previously discussed. Conversely, the dolomite growth perpendicular to the flow direction 904 may be seen to be mostly uniform both in FIG. 9 and in FIG. 8A.

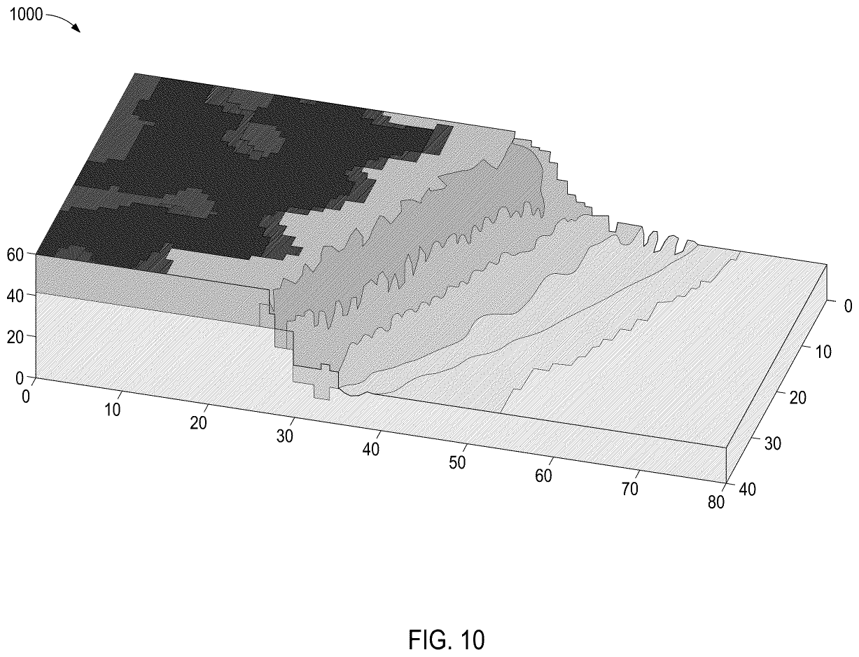

Returning briefly to FIG. 7, if the dolomite geo-object 902 of FIG. 9 satisfies the required spatial distribution for dolomite growth, the final depositional geological model may be generated through the selection of the final model button 712. The final model button 712 may generate a depositional geological model similar to the input model, but will include the dolomite geo-object 902 of FIG. 9 which has grown within the depositional model. In some cases, however, the dolomite geo-object 902 of FIG. 9 may fail to meet the spatial distribution requirements, may produce unphysical results, or may be deemed imperfect by a user. In these cases, the growth parameter window 700 may be revisited to alter the growth parameters to produce a new dolomite geo-object 902, and the process may be iterated until desired results are obtained. Once the desired results are obtained, the final model button 712 may be selected to generate a final model. FIG. 10 is an example plot of a final model 1000 formed from the initial depositional geological model and the dolomite geo-object 902 of FIG. 9. The displayed final model 1000 may then be exported or output in the presented form, such that the final model 1000 may be utilized as an initial surface template for a future depositional step in a further simulation, such as a forward depositional modeling program. In this way, the initial depositional geological model is integrated with an object-based dolomite geological model for further depositional simulations.

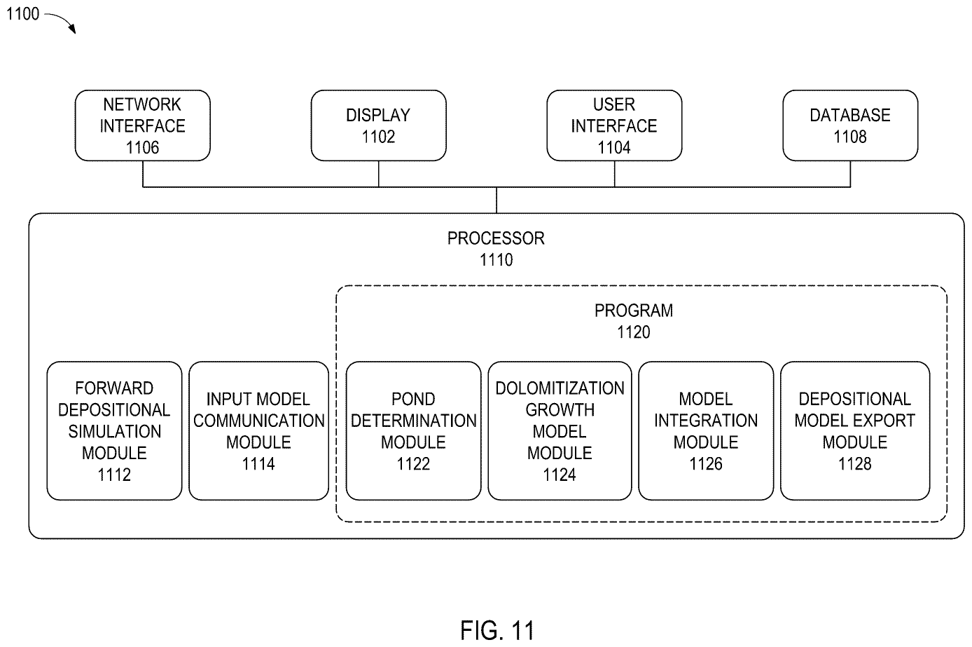

FIG. 11 is an example schematic of a system 1100 configured to perform the method 100 of FIG. 1, according to one or more embodiments of the present disclosure. The system 1100 may further run the underlying application or present the GUIs and plots outlined in FIGS. 2-10. The system 1100 may include a display 1102 and a user interface 1104 which enable the use of the GUIs previously shown herein. The display 1102 may depict the models and outputs shown in FIGS. 2-10 to allow for a user to view outputs of an underlying application or series of modules. Similarly, the user interface 1104 may comprise any device which enables a user to manipulate the underlying application or series of modules, or provide inputs to the system 1100. The user interface 1104 may include, but is not limited to, a touchscreen, a keyboard, and/or a mouse. Along with the display 1102 and user interface 1104, the system 1100 may include a network interface 1106 and/or a database 1108. The network interface 1106 may enable the transfer or receipt of files such as models, modules, or data from additional machines either through a local connection or over the internet. The database 1108 may allow the storage of any locally saved models, modules, or data to be used within the application or series of modules, or to be referenced by a user.

Connected to the various components outlined above, a processor 1110 may enable the operation of the application or underlying modules. In some embodiments, the processor 1110 may operate a forward depositional simulation module 1112 which generates the input to the method 100 of FIG. 1. In alternate embodiments, the input model may be generated on another device and either imported over the network interface 1106 or stored on the database 1108 for use within the method 100 of FIG. 1. Regardless of the source of the input model, an input model communication module 1114 may be run by the processor 1110 as a part of the method 100 of FIG. 1. The input model communication module 1114 may receive an input model from the forward depositional simulation module 1112, the network interface 1106, or the database 1108 and converts the raw model into a series of readable datasets which may be input to a dolomite growth application 1120.

The dolomite growth application 1120 may receive the readable datasets from the input model communication module 1114 and may utilize the input for execution of the method 100 of FIG. 1. The dolomite growth application 1120 may correspond to the underlying dolomite growth application discussed with reference to FIGS. 2-10, and the GUIs and the plotted outputs may be produced as part of the dolomite growth application 1120. As outlined in method 100 of FIG. 1, the dolomite growth application 1120 may contain a series of modules which perform the required tasks. A pond determination module 1122 may be run within the dolomite growth application 1120, and may enable the selection of one or more facies from the input model to create an evaporation pond. The pond determination module 1122 may further enable the plotting of the proposed evaporation pond and may additionally provide a default setting for the facies types to be selected for the evaporation pond as previously described herein.

Similarly, the dolomite growth application 1120 may include a dolomitization growth model module 1124 which enables a user to input a series of growth parameters which will affect the dolomitization growth within the simulation. The growth parameters may be modified within the dolomitization growth model module 1124, and a geo-object of the grown dolomite may be created within the dolomitization growth model module 1124. Once the user or the dolomite growth application 1120 deem the dolomitization growth model sufficient, the dolomite growth application 1120 may utilize a model integration module 1126 to generate an object-based dolomitization growth depositional model including the original depositional input model and the dolomite geo-object generated in the dolomitization growth model module 1124. The dolomite growth application 1120 may further enable an iterative process, in which a return to any of the previously discussed modules may be possible for the correction of any issues present in the final model. The model integration module 1126 may produce the final product for the depositional modeling process, or may produce an interim result to be further used. In some embodiments, the dolomite growth application 1120 may include a depositional model export module 1128 which enable the output of the final model to be used in further simulations. The depositional model export module 1128 may produce an output file that is stored in the database 1108, transferred to another device over the network interface 1106, or retained locally for use within the forward depositional simulation module 1112 to continue the depositional modeling with an integrated object-based dolomite geological model.

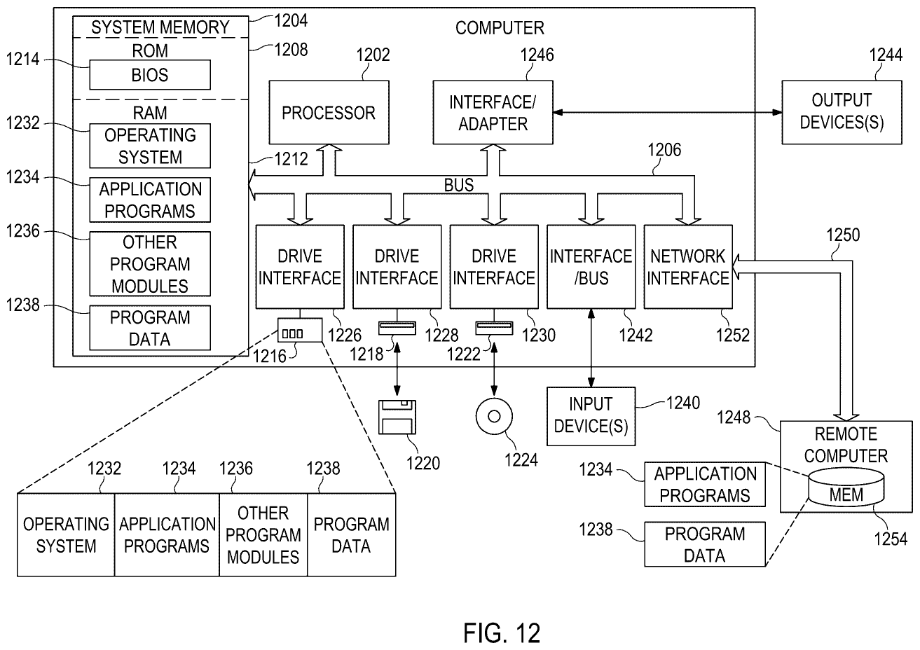

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 12. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 12 illustrates one example of a computer system 1200 that can be employed to execute one or more embodiments of the present disclosure. Computer system 1200 can be implemented on one or more general purpose networked computer systems, embedded computer systems, routers, switches, server devices, client devices, various intermediate devices/nodes or standalone computer systems. Additionally, computer system 1200 can be implemented on various mobile clients such as, for example, a personal digital assistant (PDA), laptop computer, pager, and the like, provided it includes sufficient processing capabilities.

Computer system 1200 includes processing unit 1202, system memory 1204, and system bus 1206 that couples various system components, including the system memory 1204, to processing unit 1202. Dual microprocessors and other multi-processor architectures also can be used as processing unit 1202. System bus 1206 may be any of several types of bus structure including a memory bus or memory controller, a peripheral bus, and a local bus using any of a variety of bus architectures. System memory 1204 includes read only memory (ROM) 1210 and random access memory (RAM) 1212. A basic input/output system (BIOS) 1214 can reside in ROM 1210 containing the basic routines that help to transfer information among elements within computer system 1200.

Computer system 1200 can include a hard disk drive 1216, magnetic disk drive 1218, e.g., to read from or write to removable disk 1220, and an optical disk drive 1222, e.g., for reading CD-ROM disk 1224 or to read from or write to other optical media. Hard disk drive 1216, magnetic disk drive 1218, and optical disk drive 1222 are connected to system bus 1206 by a hard disk drive interface 1226, a magnetic disk drive interface 1228, and an optical drive interface 1230, respectively. The drives and associated computer-readable media provide nonvolatile storage of data, data structures, and computer-executable instructions for computer system 1200. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 1210, including operating system 1232, one or more application programs 1234, other program modules 1236, and program data 1238. In some examples, the application programs 1234 can include the dolomite growth application 1120 as a whole, the forward depositional simulation module 1112, the input model communication module 1114, the pond determination module 1122, the dolomitization growth model module 1124, the model integration module 1126, and/or the depositional model export module 1128. Similarly, the program data 1238 can include any of the imported or exported models, the parameters read into the GUIs, the plotted datasets, and any other pertinent data. The application programs 1234 and program data 1238 can include functions and methods programmed to integrate depositional geological models with an object-based dolomite geological model for further depositional simulations, as shown and described herein.

A user may enter commands and information into computer system 1200 through one or more input devices 1240, such as a pointing device (e.g., a mouse, touch screen), keyboard, microphone, joystick, game pad, scanner, and the like. For instance, the user can employ input device 1240 to edit or modify the dolomitization growth parameters, the facies selected for evaporation ponds, or any other elements of the GUIs and plots of FIGS. 2-10. These and other input devices 1240 are often connected to processing unit 1202 through a corresponding port interface 1242 that is coupled to the system bus, but may be connected by other interfaces, such as a parallel port, serial port, or universal serial bus (USB). One or more output devices 1244 (e.g., display, a monitor, printer, projector, or other type of displaying device) is also connected to system bus 1206 via interface 1246, such as a video adapter.

Computer system 1200 may operate in a networked environment using logical connections to one or more remote computers, such as remote computer 1248. Remote computer 1248 may be a workstation, computer system, router, peer device, or other common network node, and typically includes many or all the elements described relative to computer system 1200. The logical connections, schematically indicated at 1250, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1200 can be connected to the local network through a network interface or adapter 1252. When used in a WAN networking environment, computer system 1200 can include a modem, or can be connected to a communications server on the LAN. The modem, which may be internal or external, can be connected to system bus 1206 via an appropriate port interface. In a networked environment, application programs 1234 or program data 1238 depicted relative to computer system 1200, or portions thereof, may be stored in a remote memory storage device 1254.

Embodiments disclosed herein include:
A. A method comprising: importing an input depositional geological model of a formation; identifying one or more facies types as a location for one or more evaporation ponds and subsequent dolomite growth; defining dolomitization growth parameters of the one or more evaporation ponds; constructing a dolomite growth model; and integrating the dolomite growth model into an output depositional geological model of the formation including one or more dolomite geo-objects.
B. A system comprising: an input model communication module operable to import an input depositional geological model; a pond determination module operable to identify one or more facies types of the input depositional geological model as evaporation ponds and dolomite growth locations; a dolomitization growth module operable to receive dolomitization growth parameters as inputs and generate a dolomite geo-object from the dolomitization growth parameters and the dolomite growth locations; and a model integration module operable to integrate the dolomite geo-object into the input depositional geological model to generate an output depositional geological model.
C. A non-transitory machine-readable storage medium having stored thereon a computer program for generating a dolomite geo-object and integrating the dolomite geo-object into an input depositional geological model, the computer program comprising a routine of set instructions for causing a machine to: receive the input depositional geological model from a program on the machine, a database on the machine, a remote machine, or any combination thereof; identify one or more facies types of the input depositional geological model as one or more locations for evaporation ponds and dolomite growth; determine dolomitization growth parameters within the one or more locations for evaporation ponds and dolomite growth; construct the dolomite geo-object from the dolomitization growth parameters and the one or more locations for evaporation ponds and dolomite growth; and integrate the dolomite geo-object into the input depositional geological model, creating an output depositional geological model.

Each of embodiments A through C may have one or more of the following additional elements in any combination: Element 1: wherein the input depositional geological model comprises stratigraphic spatial architectures selected from the group consisting of a thickness of the formation, a lithology of the formation, one or more petrophysical properties of the formation, and any combination thereof. Element 2: further comprising determining whether a spatial distribution is satisfied by the dolomite growth model, altering the dolomitization growth parameters in response to the dolomite growth model, and constructing a further dolomite growth model. Element 3: wherein the input depositional geological model is obtained from a forward depositional modelling software. Element 4: further comprising outputting the output depositional geological model of the formation into the forward depositional modelling software, and performing further forward depositional modelling simulations using the output depositional geological model as an initial surface template. Element 5: wherein the dolomitization growth parameters are defined from reactive transport modelling results. Element 6: further comprising visualizing, on a display of an electronic device, one or more interim results selected from the group consisting of the input depositional geological model, the one or more evaporation ponds identified, a facies map of the formation, the dolomite growth model, the output depositional geological model, and any combination thereof, and altering one or more inputs to the method based upon the interim results visualized. Element 7: further comprising displaying, on the display of the electronic device, one or more graphical user interfaces configured to receive the one or more inputs to the method based upon the interim results visualized. Element 8: further comprising a forward depositional simulation module operable to generate the input depositional geological model to be imported by the input model communication module, and a depositional model export module operable to export the output depositional geological model. Element 9: wherein the depositional model export module is operable to export the output depositional geological model to the forward depositional simulation module, and wherein the forward depositional simulation module is further operable to receive the output depositional geological model as an input for further forward depositional simulations. Element 10: further comprising a display operable to visualize one or more interim results from the input model communication module, the pond determination module, the dolomitization growth module, the model integration module, or any combination thereof. Element 11: further comprising a user interface operable to receive input from a user in response to the one or more interim results visualized on the display. Element 12: further comprising a network interface operable to send output depositional geological models, receive input depositional geological models, receive additional simulation results, or any combination thereof from one or more remote systems. Element 13: further comprising a database storing output depositional geological models, input depositional geological models, additional simulation results, or any combination thereof. Element 14: wherein one or more modules of the system are included in a dolomite growth application operable to iterate through the one or more modules, access the one or more modules simultaneously, and provide real-time modifications to one or more interim results from the one or more modules. Element 15: the set of instructions further causing the machine to perform one or more forward depositional model simulations, generating the input depositional geological model, and perform one or more further forward depositional model simulations using the output depositional geological model as an initial surface template. Element 16: the set of instructions further causing the machine to display one or more interim results of the input depositional geological model, the one or more locations for evaporation ponds and dolomite growth, the dolomite geo-object, the output depositional geological model, or any combination thereof. Element 17: the set of instructions further causing the machine to receive one or more inputs from a user of the machine, and alter the input depositional geological model, the one or more locations for evaporation ponds and dolomite growth, the dolomitization growth parameters, the dolomite geo-object, the output depositional geological model, or any combination thereof in response to the one or more inputs from the user of the machine.

By way of non-limiting example, exemplary combinations applicable to A through C include: Element 3 with Element 4; Element 6 with Element 7; Element 8 with Element 9; and Element 10 with Element 11.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method comprising:
importing an input depositional geological model of a formation;
identifying one or more facies types as a location for one or more evaporation ponds and subsequent dolomite growth;
defining dolomitization growth parameters of the one or more evaporation ponds;
constructing a dolomite growth model; and
integrating the dolomite growth model into an output depositional geological model of the formation including one or more dolomite geo-objects.

2. The method of claim 1, wherein the input depositional geological model comprises stratigraphic spatial architectures selected from the group consisting of a thickness of the formation, a lithology of the formation, one or more petrophysical properties of the formation, and any combination thereof.

3. The method of claim 1, further comprising:
determining whether a spatial distribution is satisfied by the dolomite growth model;
altering the dolomitization growth parameters in response to the dolomite growth model; and
constructing a further dolomite growth model.

4. The method of claim 1, wherein the input depositional geological model is obtained from a forward depositional modelling software.

5. The method of claim 4, further comprising:
outputting the output depositional geological model of the formation into the forward depositional modelling software; and
performing further forward depositional modelling simulations using the output depositional geological model as an initial surface template.

6. The method of claim 1, wherein the dolomitization growth parameters are defined from reactive transport modelling results.

7. The method of claim 1, further comprising:
visualizing, on a display of an electronic device, one or more interim results selected from the group consisting of the input depositional geological model, the one or more evaporation ponds identified, a facies map of the formation, the dolomite growth model, the output depositional geological model, and any combination thereof; and
altering one or more inputs to the method based upon the interim results visualized.

8. The method of claim 7, further comprising:
displaying, on the display of the electronic device, one or more graphical user interfaces configured to receive the one or more inputs to the method based upon the interim results visualized.

9. A system comprising:
an input model communication module operable to import an input depositional geological model;
a pond determination module operable to identify one or more facies types of the input depositional geological model as evaporation ponds and dolomite growth locations;
a dolomitization growth module operable to receive dolomitization growth parameters as inputs and generate a dolomite geo-object from the dolomitization growth parameters and the dolomite growth locations; and
a model integration module operable to integrate the dolomite geo-object into the input depositional geological model to generate an output depositional geological model.

10. The system of claim 9, further comprising:
a forward depositional simulation module operable to generate the input depositional geological model to be imported by the input model communication module; and
a depositional model export module operable to export the output depositional geological model.

11. The system of claim 10, wherein the depositional model export module is operable to export the output depositional geological model to the forward depositional simulation module, and wherein the forward depositional simulation module is further operable to receive the output depositional geological model as an input for further forward depositional simulations.

12. The system of claim 9, further comprising:
a display operable to visualize one or more interim results from the input model communication module, the pond determination module, the dolomitization growth module, the model integration module, or any combination thereof.

13. The system of claim 12, further comprising:
a user interface operable to receive input from a user in response to the one or more interim results visualized on the display.

14. The system of claim 9, further comprising:
a network interface operable to send output depositional geological models, receive input depositional geological models, receive additional simulation results, or any combination thereof from one or more remote systems.

15. The system of claim 9, further comprising:
a database storing output depositional geological models, input depositional geological models, additional simulation results, or any combination thereof.

16. The system of claim 9, wherein one or more modules of the system are included in a dolomite growth application operable to iterate through the one or more modules, access the one or more modules simultaneously, and provide real-time modifications to one or more interim results from the one or more modules.

17. A non-transitory machine-readable storage medium having stored thereon a computer program for generating a dolomite geo-object and integrating the dolomite geo-object into an input depositional geological model, the computer program comprising a routine of set instructions for causing a machine to:
receive the input depositional geological model from a program on the machine, a database on the machine, a remote machine, or any combination thereof;
identify one or more facies types of the input depositional geological model as one or more locations for evaporation ponds and dolomite growth;
determine dolomitization growth parameters within the one or more locations for evaporation ponds and dolomite growth;
construct the dolomite geo-object from the dolomitization growth parameters and the one or more locations for evaporation ponds and dolomite growth; and
integrate the dolomite geo-object into the input depositional geological model, creating an output depositional geological model.

18. The machine-readable storage medium of claim 17, the set of instructions further causing the machine to:
perform one or more forward depositional model simulations, generating the input depositional geological model; and
perform one or more further forward depositional model simulations using the output depositional geological model as an initial surface template.

19. The machine-readable storage medium of claim 17, the set of instructions further causing the machine to:
display one or more interim results of the input depositional geological model, the one or more locations for evaporation ponds and dolomite growth, the dolomite geo-object, the output depositional geological model, or any combination thereof.

20. The machine-readable storage medium of claim 17, the set of instructions further causing the machine to:
receive one or more inputs from a user of the machine; and
alter the input depositional geological model, the one or more locations for evaporation ponds and dolomite growth, the dolomitization growth parameters, the dolomite geo-object, the output depositional geological model, or any combination thereof in response to the one or more inputs from the user of the machine.
